(19) United States
(12) Patent Application Publication
(10) Pub. No.: US 2007/0058051 A1
(43) Pub. Date: Mar. 15, 2007

(54) Replaceable imaging device and camera body capable of removably receiving same

(75) Inventor: Nobuo Suzuki, Kanagawa (JP)

Correspondence Address: SUGHRUE-265550, 2100 PENNSYLVANIA AVE. NW, WASHINGTON, DC, 20037-3213, US

(73) Assignee: FUJI PHOTO FILM CO., LTD.

(21) Appl. No.: 11/514,892

(22) Filed: Sep. 5, 2006

(30) Foreign Application Priority Data
Sep. 7, 2005 (JP) P.2005-259326

(51) Int. Cl. H04N 5/76

(52) U.S. Cl. 348/231.3

(57) ABSTRACT

Disclosed are a camera body and a replaceable imaging device to be removably received therein. An aligning section is provided to regulate the imaging element such that a light-receiving area thereof coincides with an imaging surface of an imaging optical system of the camera body in a state the replaceable imaging device is received in the camera body. The replaceable imaging device has a control section that starts to control the image-taking operation according to an image-taking start signal supplied from the camera body and outputs a signal of an image captured to the camera body.

### BACKGROUND OF THE INVENTION

1. Field of the Invention

The present invention relates to imaging devices, and more particularly to a replaceable imaging device to be easily, removably received in a camera body and to a camera body capable of removably receiving such a replaceable imaging device.

2. Description of the Related Art

Conventionally, analog cameras (film-based cameras) are broadly spread into existence one or more in the number per household. Meanwhile, along with the recent rapid disseminations of digital cameras (electronic cameras), the occasions to use analog cameras tend to decrease. There are many common components between the analog and digital cameras in respect of their optical lens systems, the shutters, etc. However, a significant difference lies in that the analog camera detects an optical image at its silver halide film whereas the digital camera perceives an optical image at its imaging element. Thus the both are used as quite independent cameras. For this reason, the user who bought a digital camera owns two types of cameras so that he/she uses those separately in accordance with use purpose or becomes not using the older analog camera at all. In any of the cases, it is wasteful of resources not to use the analog camera whose optical lens system is yet usable. In order to avoid such waste of resources; studies have been made to utilize the analog camera as a digital camera, e.g. in JP-A-11-55557 and JP-A-2000-261708. In those, an integration part, including an imaging element, an image processor, an image recorder, a control and so on (an imaging element card or electronic film device), is attached in a receptacle of an analog camera so that the operations can be made from taking an image up to recording thereof by merely opening and closing the back lid, film winding up and shutter operation. This makes it possible to utilize the analog camera as a digital camera.

However, such a camera actually has such defects as poor response to the best timing for taking an image, short battery life and worse image quality. The reasons are explained in the following.

(1) Poor Response to the Best Timing for Taking an Image

The digital camera becomes ready when the power switch is put on at an instance of taking an image. On the contrary, the camera proposed is first becomes ready after opening the back lid of the camera and loading an imaging element card or electronic film device followed by closing the back lid. It takes several seconds, possibly encounters a case to miss the best timing.

(2) Short Battery Life

Where the imaging element card or electronic film device is always loaded with a priority to the response to the best timing or where forgetting to unload the imaging element card or electronic film device after taken an image, the operative status is kept at all times with power put on thus resulting in a possibility of battery life expiration. This makes it impossible to take a desired number of images.

(3) Poor Image Quality

In the imaging element card or electronic film device, the imaging element becomes an integration state (exposure state) after power is put on, to detect a film winding made after opening and closing of the mechanical shutter. By outputting an electric signal out of the imaging element, an electric signal is obtained corresponding to an optical image as determined from a shutter time of the mechanical shutter. The electric signal is processed, and recorded as an image signal to a storage medium. However, in case the imaging element is placed in an integration state at from a time of powering on, there is encountered an increase of fixed pattern noise due to dark current thus resulting in deterioration of image quality. In order to avoid this, there is a need to reset the electric signal of the imaging element immediately before or after opening of the mechanical shutter. However, because no mechanical-shutter start signal has been sent from the analog camera to the imaging element card or electronic film device, such an operation is impossible to perform.

In view of the above, there is a practical difficulty in reusing the analog camera as a digital camera in a manner described in JP-A-11-55557 and JP-A-2000-261708.

The widespread digital camera whose optical lens system and imaging element are integrated together, there are defects in respect of wastefulness of resources and of increased cost for the digital camera. Meanwhile, the digital camera of a single-lens reflex type involves similar defects to the widespread digital camera except for reusability of its optical lens. The reasons are explained in the following.

(1) Wastefulness of Resources

The performance improvement (particularly, in pixel count) is at a rapid pace for the imaging elements for use on the digital cameras. For the widespread camera whose optical lens system and imaging element are integrated together, the user purchases a new camera each time the imaging element performance is improved, and hence he/she no longer uses the older digital camera. The majority of parts other than the imaging element remain usable including the optical lens system (reusable for the single-lens reflex type), the optical view finder, the shutter, the electronic components and the display. Nevertheless, the user no longer uses the older digital camera. This is wasteful of resources.

(2) Cost Increase for the Digital Camera

The performance improvement (particularly, in pixel count) is at a rapid pace for the imaging elements for, use on the digital cameras. For the widespread camera whose optical lens system and imaging element are integrated together, development and manufacture is made for a new digital camera each time a new imaging element is adopted, despite the majority of parts other than the imaging element remain usable including the optical lens system excluding the imaging element, the shutter, the electronic components and the display. This increases developing personnel cost and manufacturing expenses thus incurring a mount-up of digital camera cost.

### SUMMARY OF THE INVENTION

The present invention has been made in view of the above circumstances, and it is an object thereof to provide a replaceable imaging device, integrally having an imaging element and its peripheral circuits (a control, a signal processor and a memory), to be removably received in a camera body, and a camera body arranged to removably receive therein such a replaceable imaging device whereby it can be easily changed with another replaceable imaging device.

The object of the invention is to be achieved by the following structure.

(1) A replaceable imaging device to be removably received in a camera body, the replaceable imaging device comprising: a board; an imaging element-that converts an optical image into an electric signal; a signal processing section that outputs an image signal, in which the electric signal from the imaging element is processed, to the camera body; a control section that performs control by receiving a signal and data from the camera body; and a memory that stores data related to the replaceable imaging device, wherein the imaging element, the signal processing section, the control section and the memory are provided on the board, wherein the replaceable imaging device further comprises an aligning section to regulate the imaging element such that a light-receiving area of the imaging element coincides with an imaging surface of an imaging optical system of the camera body, and wherein the control section starts to control an image-taking operation according to an image-taking start signal supplied from the camera body, and the signal processing section outputs the image signal captured to the camera body.

(2) A replaceable imaging device as set forth in the above (1), wherein the image-taking start signal comprises a still-image-taking start signal, the control section starts to control a still-image-taking operation according to the still-image-taking start signal, and the signal processing section outputs a signal of a still image captured to the camera body.

(3) A replaceable imaging device as set forth in the above (1) or (2), wherein the image-taking start signal comprises a moving-image-taking start signal, the control section starts to control a moving-image-taking operation according to the moving-image-taking start signal, and the signal processing section outputs a signal of a moving image captured to the camera body.

(4) A replaceable imaging device as set forth in the above (3), wherein control of the moving-image-taking operation is ceased according to a moving-image-taking complete signal from the camera body, and the outputting of the signal of, the moving image to the camera body is ceased.

(5) A replaceable imaging device as set forth-in any one of the above (1) to (4), wherein the aligning section is a plurality of imaging device-end reference surfaces provided corresponding respectively to at least three body-end reference surfaces provided on the camera body, and the imaging surface of the camera body and the body-end reference surfaces have a relative positional relationship coincident with a relative positional relationship between the light-receiving area and the imaging device-end reference surfaces.

(6) A replaceable imaging device as set forth in any one of the above (1) to (5), further comprising an interface that inputs/outputs a signal and data to/from the camera body in a state the replaceable imaging device is received in the camera body.

(7) A replaceable imaging device as set forth in the above (6), wherein the signal and data, to be inputted/outputted to/from the camera body through the interface, relates to at least one of: a control clock signal; a for-control-section input/output control signal; a for-image-signal clock signal; a for-image-signal input/output control signal; a synchronizing signal; performance information about imaging element (such as pixel count, sensitivity and saturation output); operating information the replaceable imaging device is compatible with; an image-signal output form; a shutter period; focus control; and exposure control.

(8) A replaceable imaging device as set forth in any one of the above (1) to (7), wherein the signal processing section corrects the electric signal from the imaging element depending upon a pixel-failure information about the imaging element stored in the memory.

(9) A replaceable imaging device as set forth in,any one of the above (1) to (8), wherein the image signal is an electric signal from the imaging element.

(10) A replaceable imaging device as set forth in any one of the above (1) to (9), wherein the image signal comprises (i) a three-primary-color signal or (ii) a luminance signal and a chrominance signal that are converted from the three-primary-color signal.

(11) A replaceable imaging device as set forth in any one of the above (1) to (10), wherein the image signal is a compressed image signal.

(12) A replaceable imaging device as set forth in any one of the above (1) to (11), further comprising an imaging device-end terminal provided at an exterior of the board, to allow an inputting/outputting of a signal and data to/from and a power supply from the camera body by electrically connecting the imager-end terminal with an body-end terminal provided on the camera body.

(13) A camera body comprising: a receptacle that removably receives therein a replaceable imaging device that outputs an image signal corresponding to an optical image inputted to a light-receiving area of the imaging element; an imaging optical system; an operating section; a power source; a camera-control section; and a camera-signal processing section that processes an image signal supplied from the replaceable imaging device or from a storage medium; wherein the receptacle comprises: an aligning section; and a fixing unit that fixes the replaceable imaging device, such that the light-receiving area of the replaceable imaging device coincides with an imaging surface of the imaging optical system, and wherein the camera-control section supplies an image-taking signal to the replaceable imaging device and controls an image-taking operation of the replaceable imaging device.

(14) A camera body as set forth in the above (13), further comprising a storage medium that stores an image signal, to effect control to store an image signal supplied from the replaceable imaging device to the storage medium when the replaceable imaging device performs an image-taking operation.

(15) A camera body as set forth in the above (14), further comprising a moving-image recording switch, wherein the camera control section supplies a moving-image-taking start signal to the replaceable imaging device in accordance with an operation of the moving-image recording switch and causes the replaceable imaging device to perform a moving-image taking operation and stores a moving-image signal supplied from the replaceable imaging device to the storage medium, and the camera control section supplies a moving-image-taking complete signal to the replaceable imaging device when the moving-image recording switch is put off and ceases from storing the moving-image signal to the storage medium.

(16) A camera body as set forth in any one of the above (13) to (15), further comprising a mechanical shutter, wherein, in taking a still image, at least one is to be selected of: a shutter operation that an exposure time is determined by the mechanical shutter; a shutter operation that the mechanical shutter is placed in an open state and an exposure time is determined by the replaceable imaging device; and,a shutter operation that an exposure time is determined by the replaceable imaging device and the mechanical shutter is closed in a period of reading a signal out of the light-receiving area.

(17) A camera body as set forth in any one of the above (14) to (16), wherein the camera-signal processing section compresses an image signal supplied from the replaceable imaging device and stores the compressed image signal to the storage medium.

(18) A camera body as set forth in any one of the above (14) to (17), further comprising a display, wherein the display makes a display of a moving-image signal when taking a moving image and a display of a still-image signal when taking a still image.

(19) A camera body as set forth in the above (18), wherein the display makes a display of a reproduced image signal in which the image signal stored in the storage medium is processed and decompressed in the camera-signal processing section, when reproducing the image signal recorded in the storage medium.

(20) A camera body as set forth in any one of the above (13) to (19), wherein the aligning section is at least three body-end reference surfaces in a predetermined positional relationship with the imaging surface of the imaging optical system.

(21) A camera body as set forth in any one of the above (13) to (20), wherein the fixing unit is a biasing member urging the body-end reference surface toward the replaceable imaging device.

(22) A camera body as set forth in any one of the above (14) to (16), wherein the storage medium is attachable and detachable.

### BRIEF DESCRIPTION OF THE DRAWINGS

FIG. 1 is a diagram explaining a camera system having a replaceable imaging device and a camera body;

FIG. 2 is a plan view explaining a state of alignment of between an imaging surface of the camera body and a light-receiving area of the replaceable imaging device;

FIG. 3 is a sectional view as viewed along the arrow B-B of the replaceable imaging device in FIG. 2; and

FIG. 4 is a sectional view as viewed along the arrow C-C of the replaceable imaging device in FIG. 2.

### DETAILED DESCRIPTION OF THE INVENTION

An embodiment of the present invention will now be explained in detail on the basis of the drawings.

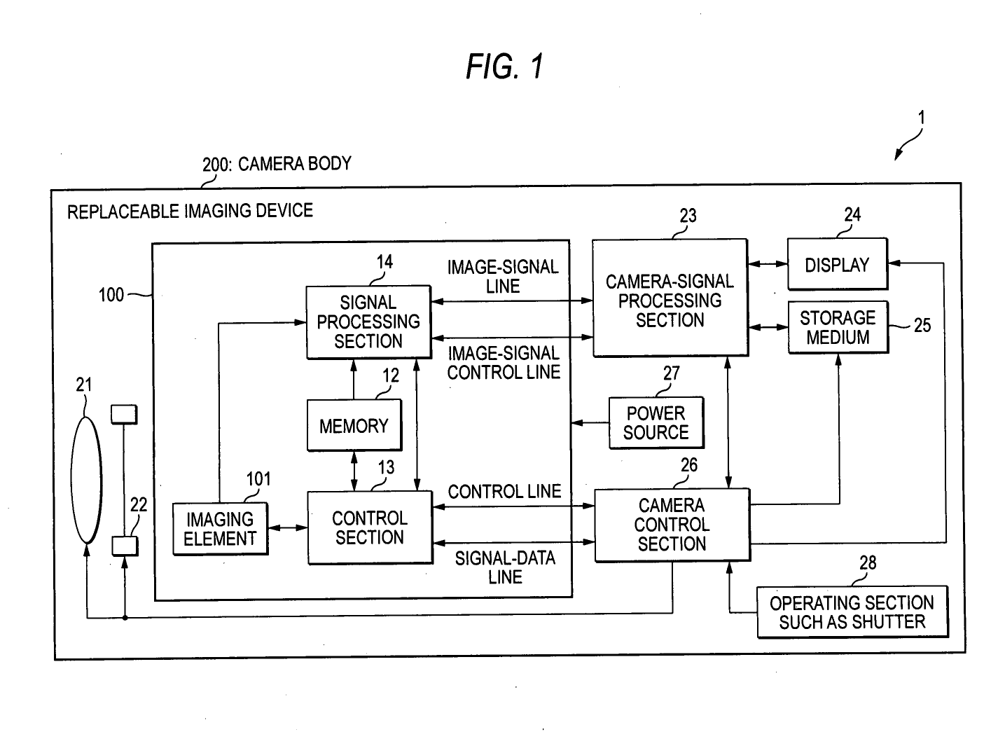

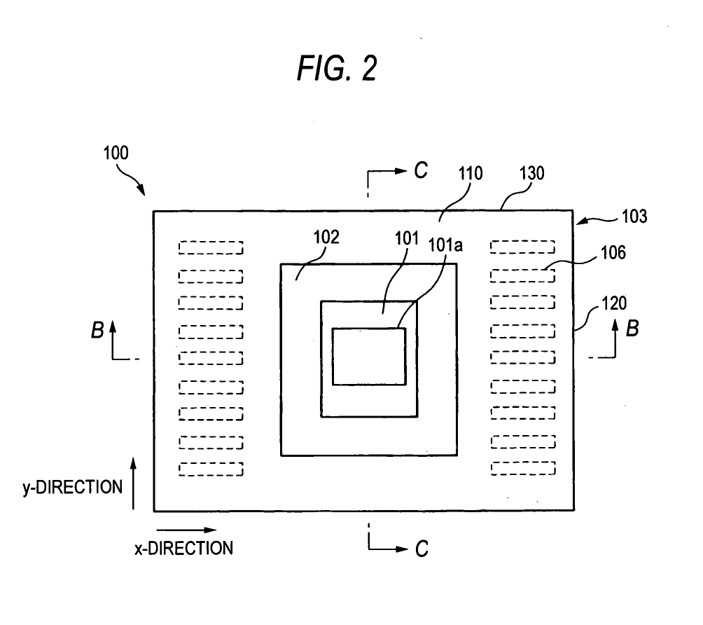

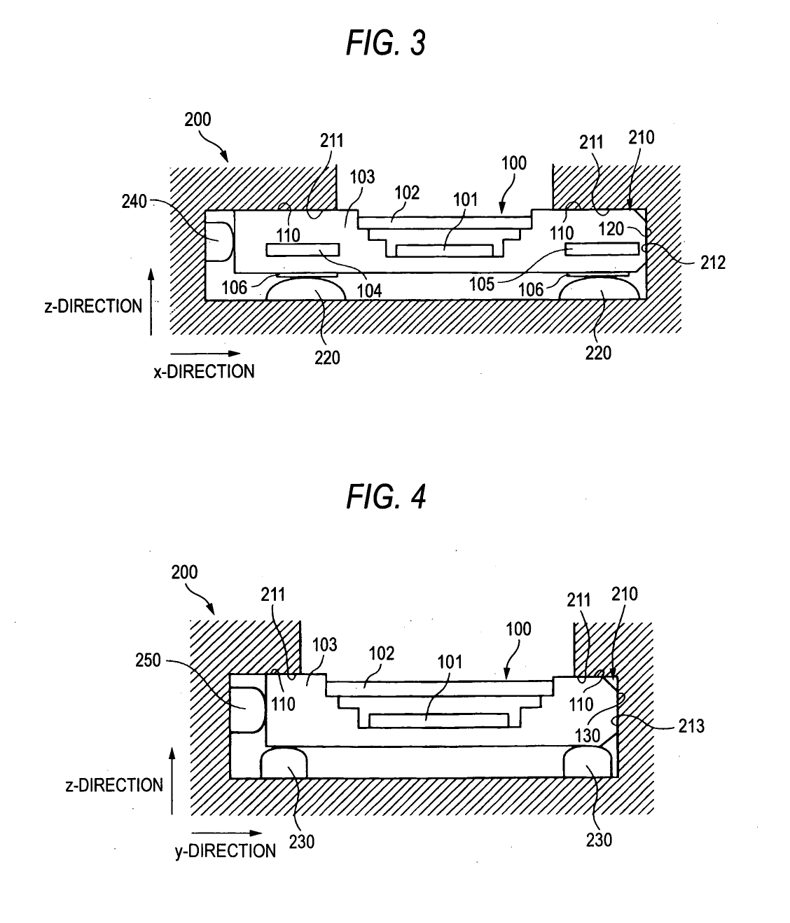

FIG. 1 shows a replaceable imaging device and camera body in one embodiment. FIG. 1 is a figure explaining a camera system having a replaceable imaging device and a camera body. FIG. 2 is a plan view explaining an alignment state of between an imaging surface of the camera body and a light-receiving area of the replaceable imaging device. FIG. 3 is a sectional view as viewed along the arrow B-B of the replaceable imaging device in FIG. 2. FIG. 4 is a sectional view as viewed along the arrow C-C of the replaceable imaging device in FIG. 2.

The camera system 1 includes a camera body 200 and a replaceable imaging device 100 to be removably received in the camera body 200.

The replaceable imaging device 100 includes a board 103, an imaging element 101, and a control section 13 and signal-processing section 14 electrically connected to the imaging element 101. The replaceable imaging device 100 also has a memory 12 electrically connected to the control section 13 and to the signal-processing section 14.

The camera body 200 has an imaging optical system 21 including a lens optical system, a mechanical shutter 22, a camera-signal processing section 23, a display 24, a storage medium 25, a camera-control section 26, a power source 27, and an operating section 28 such as a shutter. The camera-control section 26 is electrically connected to the imaging optical system 21, the mechanical shutter 22, the camera-signal processing section 23 and the storage medium 25. The camera-control section 26 is to output a predetermined signal onto the display 24.

The light-receiving area of the replaceable imaging device 100 (the light-receiving area 101a of the imaging element 101) is desirably in a size corresponding to the size of the imaging surface of the imaging optical system 21 of the camera body 200. However, the size ranges variously from 35-mm film size up ⅓-type or smaller. In case the exterior size of the replaceable imaging device 100 should be standardized to cope with all of those cases, the following disadvantage is encountered. Namely, this results in a light-receiving area 101a the greatest in size, which unnecessarily requires the size for the smaller light-receiving area 101a of the replaceable imaging device 100 and the camera body 200 receiving the same. For this-reason, the invention desirably provides several standards (e.g. 35-mm size, APS size, 4/3 type, ⅔ type, ½ type and ⅓ type) of exterior size. Where the light-receiving area 101a is in a size not suited for a standardized size, there is possibly an occurrence of a somewhat change in optical magnification or of a some change in peripheral resolution. Such a change is practically allowable, and hence precise standardization is not needed. Meanwhile, for the ⅓-type or smaller, the components of control and signal-processing ICs are mounted on the replaceable imaging device 100 wherein the replaceable imaging device 100 is not size-reduced even where the imaging element 101 is made smaller. Thus, there is no need of standardization for the light-receiving area 101a smaller in size.

As shown in FIG. 1, the camera body 200 receiving therein the replaceable imaging device 100 is in similar structure to the usual digital camera excepting that the arrangement is separated as the camera-control section 26 for the camera body 200 and the control section 13 for the replaceable imaging device 100. Programming is made to assign roles respectively to the camera-control section 26 of the camera body 200 and the control section 13 of the replaceable imaging device 100 so that those can function as a one-body digital camera. This makes it possible to perform a still and moving picture photography similarly to the usual digital camera.

Meanwhile, the replaceable imaging device 100 can be changed with another replaceable imaging device 100 if equal in exterior size as shown in FIG. 2. Devising is made to align the light-receiving area 101a of the replaceable imaging device 100 nearly with the imaging surface of the camera body 200. Programming is made such that, even where there is a change of pixel count, sensitivity, etc. in the light-receiving-section 101a of the imaging element 101, the camera-control section 26 of the camera body 200 and the control section 13 of the replaceable imaging device 100 are allowed to function as a one-body digital camera by the use of the data stored in the memory 12 of the replaceable imaging device 100. As a result, operation is possible to effect as a digital camera mounted with a new imaging element having a characteristic of new pixel count, new sensitivity, etc.

As shown in FIG. 2, the replaceable imaging device 100 has a board 103 rectangular in plan view, an imaging element 101 fixed on a recessed bottom in the center of the board 103, and a sealing transparent plate 102, such as of glass, attached in a manner closing the recess where the imaging element 101 is fixed.

As shown in FIGS. 2 and 3, body-end terminals 220 are provided in a bottom of an interior of the receptacle 210 of the camera 200. Meanwhile, input/output terminals 106, serving as imaging device-end terminals, are provided on a bottom of the board 103 of the replaceable imaging device 100. The input/output terminals 106 are provided in plurality on the board 103, at both ends of a region fixing the solid-state imaging element with respect to x-direction and with spacing in y-direction.

In a state the replaceable imaging device 100 is received in the receptacle 210 of the camera body 200, electric connection is provided to between the input/output terminals 106 of the board 103 and the body-end terminals 220. The input/output terminals 106 are connected to the control and signal-processing section ICs and other electric/electronic components that are shown at 104, 105 in FIG. 3, by means of not-shown circuits and wires.

Aligning section is provided as in the following, which serves to align the light-receiving area 101a of the replaceable imaging device 100 with the imaging surface of the camera body 200 upon attaching the replaceable imaging device 100 to the camera body 200 during replacement thereof.

The first requirement for the aligning section is that the light-receiving area of the imaging element 101 coincides with the imaging surface. Consequently, as shown in FIG. 2, selection is made such that the reference surface, in z-direction, of the receptacle 210 provided in the camera body 200 (z-directional reference surface) is parallel with the imaging surface, the Z-directional reference surface with respect to the direction vertical to the light-receiving area 101a of the replaceable imaging device 100 (corresponding to a depth direction in FIG. 2, hereinafter taken as z-direction) is parallel with the light-receiving area 101a and the distance between the z-directional reference surface 211 of the receptacle 210 and the imaging surface is equal to the distance between the Z-directional reference surface 110 of the replaceable imaging device 100 and the light-receiving area 101a. Herein, the distance between the z-directional reference surface 211 and the imaging surface does not mean a simple distance but means an optical distance taking account of a refractive index and thickness of the sealing glass plate attached to the replaceable imaging device 100.

The second requirement for the aligning section is that the (X-direction) parallel with the imaging surface of the camera body 200 and the (Y-direction) orthogonal thereto are coincident with the (x-direction) parallel with the light-receiving surface of the light-receiving area 101a and the (y-direction) orthogonal thereto such that the imaging surface of the camera body 200 has a center coincident with the center of the light-receiving area 101a of the imaging element 101, as shown in FIG. 2. Namely, it is desired that the rectangular image in an area taken by the camera body 200 is coincident with the rectangular light-receiving area 101a. Consequently, selection is made such that the surface parallel with the Z-direction and with the Y-direction passing the center of the imaging surface of the camera body 200 (assumed an imaging X-surface) is parallel with the reference surface 212 in X-direction of the cameras body 200, the surface parallel with the z-direction and parallel also with the y-direction passing the center of the light-receiving area (assumed as a light-receiving x-surface) is parallel, and the distance between the imaging X-surface and the x-directional reference surface 212 of the receptacle 210 is equal to the distance between the light-receiving x-surface and the x-directional reference surface 120 of the replaceable imaging device 100.

Furthermore, selection is made such that the surface parallel with Z-direction and also with X-direction passing the center of the imaging surface of the camera body 200 (assumed an imaging Y surface) is parallel with the Y-directional reference surface 213 of the receptacle 210, the surface parallel with z-direction and also with x-direction passing the center of the imaging surface of the light-receiving area 101a (assumed an imaging y surface) is parallel with, and the distance between the imaging Y-surface and the Y-directional reference surface 213 of the receptacle 210 is equal to the distance between the light-receiving y-surface and the y-directional reference surface 130 of the replaceable imaging device 100. Due to this, even when the replaceable imaging device 100 is changed, by aligning the respective reference surfaces together, the light-receiving area 101a of the replaceable imaging device 100 can be placed coincident with the imaging surface of the camera body 200.

The camera body 200 has biasing members 230, 240 250, such as springs, formed in the receptacle 210. The biasing members 230, 240, 250 serve as a fixing unit.

The biasing member 230 uses a member of a material or form having an elasticity to cause a force urging the replaceable imaging device 100 in the z-direction in the state the replaceable imaging device 100 is received in the receptacle 210. The replaceable imaging device 100, in the state received in the receptacle 210, is closely contacted, at its z-directional reference surface 110, with the X-directional reference surface 211 of the receptacle 210 by the biasing member 230.

The biasing member 240 uses a member of a material or form having an elasticity to cause a force urging the replaceable imaging device 100 in the x-direction in the state the replaceable imaging device 100 is received in the receptacle 210. The replaceable imaging device 100, in the state received in the receptacle 210, is closely contacted, at its x-directional reference surface 120, with the X-directional reference surface 211 of the receptacle 210 by the biasing member 240. Although not shown, the receptacle is made with the biasing member 240 side surface that is to be opened outward and closed therefrom. In an open state, the replaceable imaging device 100 can be removably received in the receptacle 210.

The biasing member 250 uses a member of a material or form having an elasticity to cause a force urging the replaceable imaging device 100 in the y-direction in the state the replaceable imaging device 100 is received in the receptacle 210. The replaceable imaging device 100, in the state received in the receptacle 210, is closely contacted, at its y-directional reference surface 130, with the Y-directional reference surface 213 of the receptacle 210 by the biasing member 250.

In this manner, the imaging device-end reference surfaces 110, 120, 130, provided in plurality respectively for the body-end reference surfaces 211, 212, 213, serve as an aligning section relatively to the body-end reference surfaces 211, 212, 213 provided at least three in the number in the camera body 200. Here, the relative positional relationship of the imaging surface of the camera body 200 with the body-end reference surfaces 211, 212, 213 coincides with the relative positional relationship of the light-receiving area 101a with the imaging device-end reference surfaces 211, 212, 213.

Explanation is now made on the constituent sections of the replaceable imaging device 100.

The imaging element 101 is to convert the optical image inputted to the light-receiving area 101a into an electric signal and output it, which typically is a CCD imaging element or a MOS imaging element. In order to take a color image, a color filter is provided in a mosaic form. Meanwhile, where the imaging element does not incorporate a timing generating section to generate a timing pulse for driving the imaging element 101, a timing generating section, though not shown, is provided between the control section 13 and the imaging element 101.

The signal processing section 14 performs a signal processing on the output signal from the imaging element 101 into an image signal, and outputs it to the camera body 200. Where the imaging element 10 has an analog output signal, there is provided, in the initial stage, an A-D converter section (not shown) to convert an analog signal into a digital signal. For the image signal outputted, desirably selectable is an image signal (RAW signal) not synchronization-processed but corresponding to the output signal of the imaging element, a three-primary color signal of red, green and blue synchronization-processed, or a YCrCb signal which the three-primary color signal is converted into luminance and chrominance signals. Furthermore, where the imaging element 101 and the camera body 200 are different in pixel count in a still or moving image photography, signal processing is made to output an image signal suited for the pixel count on the camera body 200.

The memory 12 is desirably a non-volatile memory, such as a ROM or a flash memory, capable of performing a once writing. This stores the data as to replaceable imaging device 100 specification, performance, image failure data, etc, required for digital camera operation. By the stored data, control and signal processing are suitably performed for the replaceable imaging device 100 and camera body 200, e.g. pixel-count regulation for an image signal and correction for image failure region.

The control section 13 serves to supply a signal or data required by the camera body 200 to the camera body 200 and to control the replaceable imaging device 100 correspondingly to the signal or data supplied from the camera body 200.

As shown in FIG. 1, a signal/data line, serving as an interface, is formed at the connection of between the replaceable imaging device 100 and the camera body 200. The signal/data line is a signal line for supplying a signal and data to be sent/received to/from the control section 13 of the replaceable imaging device 100 or the camera-control section 26. For example, transmission/reception is to be made of at least one of performance information about imaging element 101 pixel count, imaging element 101 sensitivity, saturation output, etc., operating information the replaceable imaging device 100 is compatible with, data or a related to an image-signal output form, shutter and focus control, exposure control and the like.

Meanwhile, a control line is formed at the connection of between the replaceable imaging device 100 and the camera body 200. The control line is a signal line to supply a control signal to send/receive a signal and data at between the control section 13 and the camera-control section 26. For example, those include a clock signal for the control section, a data read-write switch signal, a signal representative of data or signal presence/absence, a read/write wait signal, a synchronizing signal and so on.

Furthermore, an image signal line and an image-signal control line are formed between the signal processing section 14 of the replaceable imaging device 100 and the camera-control section 23 of the camera body 200. The image signal line is a signal line to supply an image signal to the camera body 200. The image-signal control line is a signal line to supply an image signal to the camera body 200. For example, those include a clock signal for the image signal, a synchronizing signal, a signal representative of image signal presence/absence, and so on.

Explanation is now made on the constituent sections of the camera body 200.

When taking an image, the camera-signal processing section 23 processes the image signal outputted from the replaceable imaging device 100 and outputs a displaying-image signal to the display 24. It also processes the image signal outputted from the replaceable imaging device 100 and writes an image signal to a storage medium 25. When reproducing an image, it reads an image signal out of the storage medium 25 and processes the image signal, thus outputting a displaying-image signal to the display 24. In order to reduce the image-signal storage capacity, it is desired to perform data compression upon taking an image and data decompression during reproducing an image.

The storage medium 25 is a medium to store an image signal, which typically is a magnetic tape, a CD or a DVD. The storage medium is desirably arranged to be removably received. The storage medium 25, removed from the camera body 200, can be connected to a PC, a printer or the like, to send an image signal to the PC, the printer or the like.

The display 24, when taking an image, displays a real-time moving image being captured by the replaceable imaging device 100, a still image taken or the like. When reproducing an image, it displays an image signal stored in the storage medium 25. Furthermore, it is used in making a display of camera-body 200 setting, replaceable imaging device component 100 setting, and the data, etc, stored in the memory 12 of the replaceable imaging device 100. It is typically a liquid-crystal display, an organic EL display, an electron-tube display or a plasma display.

The imaging optical system 21 is an optical lens system, such as a fixed-focus lens or a zoom lens, to focus an subject optical image onto a light-receiving area 101a of the replaceable imaging device 100. It may have an aperture-setting function.

The mechanical shutter 22 may have an aperture-setting function. There are included a scheme to determine an exposure time by opening and closing of the mechanical shutter 22, and a scheme to determine an exposure time by an electronic shutter of the imaging element 101 so that the mechanical shutter 22 can be closed in the period of reading a still image signal. The former scheme involves a defect that high-speed shutter (e.g. one-ten thousands second or shorter) is difficult to obtain and cost is higher for the mechanical shutter 22. The latter scheme is advantageous in that high-speed shutter is available and cost is low for the mechanical shutter 22. Meanwhile, when taking a moving image, the mechanical shutter 22 is placed in an open state. In the camera body 200 and replaceable imaging device 100 according to the invention, it is preferred, upon taking a still image, to select one of shutter operations, i.e. shutter operation wherein exposure time is determined by the mechanical shutter 22, shutter operation wherein exposure time is determined by the replaceable imaging device 100 with the mechanical shutter 22 placed in an open state, shutter operation wherein exposure time is determined by the replaceable imaging device 100 so that the mechanical shutter 22 can be closed in a period of reading a signal out of the light-receiving area 101a.

The camera-control section 26 is to control the camera body 200 and the replaceable imaging device 100.

The battery 27 is a power source to drive the camera body 200 and replaceable imaging device 100, which uses a primary or secondary battery.

The operating section 28, including a shutter, is a human interface allowing for the user to perform an operation of the camera body 200. This includes a shutter button, a power on/off switch, a switch or button for various setting of camera, and so on. In the operating section 28, a moving-image recording switch may be provided to start a shooting of a moving image. In response to the operation of the moving-image recording switch, the camera control section 26 supplies a moving-image start signal to the replaceable imaging device 100, thus causing the replaceable imaging device 100 to operate for taking a moving image. The moving-image signal supplied from the replaceable imaging device 100 is stored in the storage medium 25. When, the moving-image recording switch is turned off, a moving-image-taking complete signal is supplied to the replaceable imaging device 100 so that the moving-image signal can be preferably ceased from being stored to the storage medium 25.

According to the replaceable imaging device 100 and camera body 200 according to the invention, when using a new imaging element, it is satisfactory to change only the replaceable imaging device 100. Namely, only the replaceable imaging device 100 is consumed which includes the imaging element 101, the control section 13, the signal processing section 14, the memory 12, and the like. The most part of the digital camera can be reused including the imaging optical system 21, the mechanical shutter 22, the display 24, the optical view finder, the storage medium 25, the camera-control section 23, the operating section such as a shutter, housing and so on. Namely, the resources are less wasted.

Meanwhile, development expense and manufacturing cost are significantly reduced because it is satisfactory to develop only the replaceable imaging device 100. Accordingly, a great cost reduction is feasible when considered as a one-body camera.

Furthermore, the camera-control section 26 of the camera body 200 and the control section 13 of the replaceable imaging device 100 can take control of the camera body 200 and replaceable imaging device 100 in a manner to operate as an integrated digital camera. Namely, it is possible to control the shutter operation, image-signal processing/storage and power supply to the replaceable imaging device 100, similarly to the usual digital camera. Therefore, the present invention is highly responsive to the best moment for taking an image as in the usual digital camera, and long in battery life, thus obtaining a favorable image quality.

The replaceable imaging device 100 and camera body 200 in the embodiment was applicable for taking both still and moving images. However, it may be exclusive for still image photography or moving image photography.

The camera body 200 in the embodiment had the mechanical shutter 22. Alternatively, the mechanical shutter 22 may be omitted in the structure. In such a case, exposure time is regulated by an electronic shutter of the replaceable imaging device 100. This is effective for a camera body 200 arranged mainly for the purpose of taking a moving image. This arrangement can realize the reduction of cost and set size.

The camera body 200 in the embodiment had the display 24. Alternatively, the display 24 may be omitted in the structure. In such a case, the photographic scene of a subject is to be determined through the optical view finder provided on the camera body 200.

In the replaceable imaging device 100 and camera body 200 in the embodiment, image-signal compression and decompression are performed in the camera-signal processing section 23 of the camera body 200. Alternatively, image-signal compression and decompression may be made in the signal-processing section 14.

The replaceable imaging device 100 in the embodiment has an outer shape like a simple card. It is desirably in an asymmetric form not to allow the insertion of the replaceable imaging device 100 in a wrong direction.

The replaceable imaging device 100 and camera body 200 in the embodiment provided large-sized reference surfaces (occupying the greater part of the upper or side surface) respectively in x, y and z directions or in X, Y and Z directions of the camera body 200. Alternatively, those may be divided into a plurality of small reference surfaces.

The replaceable imaging device 100 in the embodiment provided the terminals in two rows in the lower surface with respect to the z-direction. Alternatively, the number and arrangement of terminals is not limited to this. Meanwhile, the surface where the terminals are provided may be a side surface opposite to the reference surface instead of the lower surface. In the case the reference surface is provided in a side surface, the reference surfaces on the camera body 200 are provided in positions corresponding to those of the replaceable imaging device 100.

The replaceable imaging device 100 and camera body 200 in the embodiment had the z-directional or Z-directional reference surface taken on the side closer to the upper surface of the replaceable imaging device 100 with respect to z-direction. Alternatively, the reference surface may be provided on the side closer to the backside.

In the camera body 200 in the embodiment, the storage medium 25 was removed and connected to an apparatus such as a PC to thereby send an image signal to the apparatus, such as a PC. Alternatively, the camera body 200 may be provided with a terminal (e.g. USB) to be connected to a PC or the liked, or means to send/receive data by means of an electromagnetic wave or infrared ray.

The camera body 200 in the embodiment had the imaging optical system 21 fixed on the camera body 200. Alternatively, the imaging optical system may be arranged removable as in the single-lens reflex camera system.

The replaceable imaging device 100 in the embodiment had the imaging element 101 made as a single-plated color imaging element. However, this is not limitative. It may be a color imaging element having a multiplicity of layers of pixels having a photosensitivity on different three colors at a sample position of one pixel. Alternatively, it may be a black-and-white imaging element.

According to the present invention, there are provided a replaceable imaging device integrally having an imaging element and its peripheral circuits (a control section, a signal processing section and a memory) and to be removably received in a camera body, and a camera body capable of easily changing the received replaceable imaging device with another replaceable imaging device.

The entire disclosure of each and every foreign patent application from which the benefit of foreign priority has been claimed in the present application is incorporated herein by reference, as if fully set forth.

What is claimed is:

1. A replaceable imaging device to be removably received in a camera body, the replaceable imaging device comprising:
a board;
an imaging element that converts an optical image into an electric signal;
a signal processing section that outputs an image signal, in which the electric signal from the imaging element is processed, to the camera body;
a control section that performs control by receiving a signal and data from the camera body; and
a memory that stores data related to the replaceable imaging device,
wherein the imaging element, the signal processing section, the control section and the memory are provided on the board,
wherein the replaceable imaging device further comprises an aligning section to regulate the imaging element such that a light-receiving area of the imaging element coincides with an imaging surface of an imaging optical system of the camera body, and
wherein the control section starts to control an image-taking operation according to an image-taking start signal supplied from the camera body, and the signal processing section outputs the image signal captured to the camera body.

2. A replaceable imaging device according to claim 1,
wherein the image-taking start signal comprises a still-image-taking start signal,
the control section starts to control a still-image-taking operation according to the still-image-taking start signal, and
the signal processing section outputs a signal of a still image captured to the camera body.

3. A replaceable imaging device according to claim 1,
wherein the image-taking start signal comprises a moving-image-taking start signal,
the control section starts to control a moving-image-taking operation according to the moving-image-taking start signal, and
the signal processing section outputs a signal of a moving image captured to the camera body.

4. A replaceable imaging device according to claim 3,
wherein control of the moving-image-taking operation is ceased according to a moving-image-taking complete signal from the camera body, and
the outputting of the signal of the moving image to the camera body is ceased.

5. A replaceable imaging device according to claim 1,
wherein the aligning section is a plurality of imaging device-end reference surfaces provided corresponding respectively to at least three body-end reference surfaces provided on the camera body, and
the imaging surface of the camera body and the body-end reference surfaces have a relative positional relationship coincident with a relative positional relationship between the light-receiving area and the imaging device-end reference surfaces.

6. A replaceable imaging device according to claim 1, further comprising an interface that inputs/outputs a signal and data to/from the camera body in a state the replaceable imaging device is received in the camera body.

7. A replaceable imaging device according to claim 6,
wherein the signal and data, to be inputted/outputted to/from the camera body through the interface, relates to at least one of: a control clock signal; a for-control-section input/output control signal; a for-image-signal clock signal; a for-image-signal input/output control signal; a
synchronizing signal; performance information about imaging element; operating information the replaceable imaging device is compatible with; an image-signal output form; a shutter period; focus control; and exposure control.

8. A replaceable imaging device according to claim 1,
wherein the signal processing section corrects the electric signal from the imaging element depending upon a pixel-failure information about the imaging element stored in the memory.

9. A replaceable imaging device according to claim 1,
wherein the image signal is an electric signal from the imaging element.

10. A replaceable imaging device according to claim 1, wherein the image signal comprises (i) a three-primary-color signal or (ii) a luminance signal and a chrominance signal that are converted from the three-primary-color signal.

11. A replaceable imaging device according to claim 1,
wherein the image signal is a compressed image signal.

12. A replaceable imaging device according to claim 1, further comprising an imaging device-end terminal provided at an exterior of the board, to allow an inputting/outputting of a signal and data to/from and a power supply from the camera body by electrically connecting the imager-end terminal with an body-end terminal provided on the camera body.

13. A camera body comprising:
a receptacle that removably receives therein a replaceable imaging device that outputs an image signal corresponding to an optical image inputted to a light-receiving area of the imaging element;
an imaging optical system;
an operating section;
a power source;
a camera-control section; and
a camera-signal processing section that processes an image signal supplied from the replaceable imaging device or from a storage medium;
wherein the receptacle comprises: an aligning section; and a fixing unit that fixes the replaceable imaging device, such that the light-receiving area of the replaceable imaging device coincides with an imaging surface of the imaging optical system, and
wherein the camera-control section supplies an image-taking signal to the replaceable imaging device and controls an image-taking operation of the replaceable imaging device.

14. A camera body according to claim 13, further comprising a storage medium that stores an image signal, to effect control to store an image signal supplied from the replaceable imaging device to the storage medium when the replaceable imaging device performs an image-taking operation.

15. A camera body according to claim 14, further comprising a moving-image recording switch,
wherein the camera control section supplies a moving-image-taking start signal to the replaceable imaging device in accordance with an operation of the moving-image recording switch and causes the replaceable imaging device to perform a moving-image taking operation and stores a moving-image signal supplied from the replaceable imaging device to the storage medium, and
the camera control section supplies a moving-image-taking complete signal to the replaceable imaging device when the moving-image recording switch is put off and ceases from storing the moving-image signal to the storage medium.

16. A camera body according to claim 13, further comprising a mechanical shutter,
wherein, in taking a still image, at least one is to be selected of: a shutter operation that an exposure time is determined by the mechanical shutter; a shutter operation that the mechanical shutter is placed in an open state and an exposure time is determined by the replaceable imaging device; and a shutter operation that an exposure time is determined by the replaceable imaging device and the mechanical shutter is closed in a period of reading a signal out of the light-receiving area.

17. A camera body according to claim 14,
wherein the camera-signal processing section compresses an image signal supplied from the replaceable imaging device and stores the compressed image signal to the storage medium.

18. A camera body according to claim 14,
further comprising a display,
wherein the display makes a display of a moving-image signal when taking a moving image and a display of a still-image signal when taking a still image.

19. A camera body according to claim 18,
wherein the display makes a display of a reproduced image signal in which the image signal stored in the storage medium is processed and decompressed in the camera-signal processing section, when reproducing the image signal recorded in the storage medium.

20. A camera body according to claim 13,
wherein the aligning section is at least three body-end reference surfaces in a predetermined positional relationship with the imaging surface of the imaging optical system.

21. A camera body according to claim 13,
wherein the fixing unit is a biasing member urging the body-end reference surface toward the replaceable imaging device.

22. A camera body according to claim 14,
wherein the storage medium is attachable and detachable.
